(19) United States
(12) Patent Application Publication
(10) Pub. No.: US 2012/0314713 A1
(43) Pub. Date: Dec. 13, 2012

(54) METHOD AND SYSTEM FOR PROXY ENTITY REPRESENTATION IN AUDIO/VIDEO NETWORKS

(76) Inventors: Harkirat SINGH, San Jose, CA (US); Ilju NA, Suwon (KR); Jae Min LEE, Suwon (KR); Chiu NGO, San Francisco, CA (US)

(21) Appl. No.: 13/491,269

(22) Filed: Jun. 7, 2012

Related U.S. Application Data
(60) Provisional application No. 61/494,825, filed on Jun. 8, 2011.

(51) Int. Cl. H04L 12/66

(52) U.S. Cl. 370/401

(57) ABSTRACT

Communication in an AV network includes a Talker device initiating communication with a Listener device via a proxy device for data streaming. The proxy device participates in one or more of: content discovery, connection establishment, AV selection and AV streaming between the Talker device initiating communication with a Listener device.

### CROSS-REFERENCE TO RELATED APPLICATION

This application claims the benefit of U.S. provisional patent application Ser. No. 61/494,825 filed on Jun. 8, 2011, incorporated herein by reference.

### FIELD OF THE INVENTION

The present invention relates generally to audio/video (AV) networks, and in particular to AV streaming in AV networks.

### DESCRIPTION OF RELATED ART

The ever increasing amount of multimedia content, and in particular, high quality multimedia content presents a number of challenges to designers and administrators of computing platforms and networks alike. In this regard, a number of standards have been developed for transporting high quality multimedia data. For example, Video Electronics Standards Association (VESA) has developed the emerging DisplayPort (DP) standard. DiiVA and HDBaseT are other recent standards developed to support high quality multimedia data transportation. In all such standards, the video path is normally unidirectional wherein between two physical ports, video data is only allowed to go unidirectional.

### BRIEF SUMMARY

According to an embodiment of the invention, communication in an AV network includes a Talker device initiating communication with a Listener device via a proxy device for data streaming. The proxy device participates in one or more of: content discovery, connection establishment, AV selection and AV streaming between the Talker device initiating communication with a Listener device.

According to an embodiment of the invention, a network-based architecture is employed such that a proxy entity is used to represent connected HDMI1.x devices. The proxy entity actively participates in content discovery, connection establishment, AV selection and AV transmission. An embodiment of the invention provides a method whereby Next Generation High-Definition Multimedia Interface device functions as a proxy between HDMI1.x devices and a next generation Next Generation HDMI Network.

These and other features, aspects and advantages of the present invention will become understood with reference to the following description, appended claims and accompanying figures.

### BRIEF DESCRIPTION OF THE DRAWINGS

FIG. 1A shows an AV network of bridged AV devices with proxy entity presentation, according to an embodiment of the invention;

FIG. 1B shows an AV network of bridged AV devices implementing Next Generation Interface (NGI) High-Definition Multimedia Interface (HDMI) protocol stack with proxy entity presentation, according to an embodiment of the invention;

FIG. 2 illustrates an NGI protocol stack for the network of FIG. 1B, according to an embodiment of the invention;

FIG. 3 illustrates AV streaming over multiple hops and across domains in an Audio Video Bridging (AVB) network, according to an embodiment of the invention;

FIG. 4 illustrates an architecture of a proxy entity, according to an embodiment of the invention;

FIG. 5 illustrates maintaining IP address table by a proxy entity, according to an embodiment of the invention;

FIG. 6 illustrates a proxy entity connection in the AV network of FIG. 2, according to an embodiment of the invention;

FIG. 7 shows a process for proxy entity transmission of HDMI1.x control messages in an AV network, according to an embodiment of the invention;

FIG. 8A shows a flowchart of talker message processing by a proxy entity, according to an embodiment of the invention;

FIG. 8B shows a flowchart of listener message processing by a proxy entity, according to an embodiment of the invention;

FIG. 9 shows a flowchart of AV format selection by a proxy entity, according to an embodiment of the invention;

FIG. 10 illustrates a process for transporting AVI Info over IEEE AVTP, according to an embodiment of the invention; and

FIG. 11 shows a block diagram of an information processing system comprising a computer system useful for implementing an embodiment of the present invention.

### DETAILED DESCRIPTION OF THE INVENTION

The present invention relates to data streaming in AV networks. According to an embodiment of the invention, a network-based architecture is employed such that a proxy entity is used to represent connected High-Definition Multimedia Interface (HDMI) entities such as HDMI1.x devices. The proxy entity actively participates in content discovery, connection establishment, AV selection and AV transmission. An embodiment of the invention provides support for bi-directional video transmission over a switched network. An embodiment of the invention provides a method whereby Next Generation HDMI device functions as a proxy between HDMI1.x devices and a next generation Next Generation HDMI Network. Next generation HDMI interface will provide backward compatibility to current generation of HDMI devices.

Audio Video Bridging (AVB) technical standard includes a set of specifications to allow transport of high-quality, time-sensitive AV applications over IEEE 802 bridged local area networks (LANs). IEEE 802.1Qat Stream Reservation Protocol (SRP) specification enables an AVB destination electronic device (commonly known as a Listener) to register a request for delivery of a specified AV stream from an AVB source electronic device (commonly known as Talker) in an AVB network. In addition, an AVB source device may request reservation of network resources, which enables the transmission of a specified AV stream. The SRP defined within the IEEE 802.1Qat specification provides a mechanism whereby the AVB source device may register a request to reserve network resources (such as bandwidth) within an AVB network to enable the transmission of the specified AV stream. A Listener indicates which data stream is to be received, and a Talker announces a data stream that can be supported by a bridged entity. Network resources are allocated and configured in both the end nodes (e.g., Talker and Listener) of a data stream and the transit nodes (e.g., bridges) along the path for data stream. An end-to-end signaling mechanism to detect the success/failure of the effort is also provided.

A typical IEEE 802.1AVB network comprises a set of AVB devices, which are collectively referred to as an AVB block or domain. An AVB network may comprise wired or optical local area networks (LANs) and/or wireless LANs (WLANs) such as 802.11ad/ac/a/g/n/ad/ac. Individual AVB devices within the AVB network may include AVB-enabled endpoint devices (e.g., TV, AV Receiver, Desktop/laptop, BlueRay Player, etc.), AVB-enabled switching devices (i.e., AV switches or bridges) within LANs and AVB-enabled access points (i.e., APs) within WLANs. Within the AVB block, AV destination devices may request AV streams from AV source devices, which may be transported across the AVB network within specified latency target values as determined from Quality of Service (QoS) descriptors associated with delivery of an AV stream.

According to an embodiment of the invention, a proxy entity (device) in an AVB network present pseudo IEEE802.1AVB talker and listener entities mapped to HDMI1.x entities including HDMI1.x source and sink devices. The proxy entity negotiates and establishes IEEE802.1AVB connections (such as 802.1Qat SRP) on behalf of HDMI1.x source and sink devices. The proxy device maintains unique IDs (e.g., GUID, IP, etc.) for HDMI1.x entities, and publishes AV content and capabilities of HDMI1.x entity at Layer-3 in Next Generation HDMI Interface.

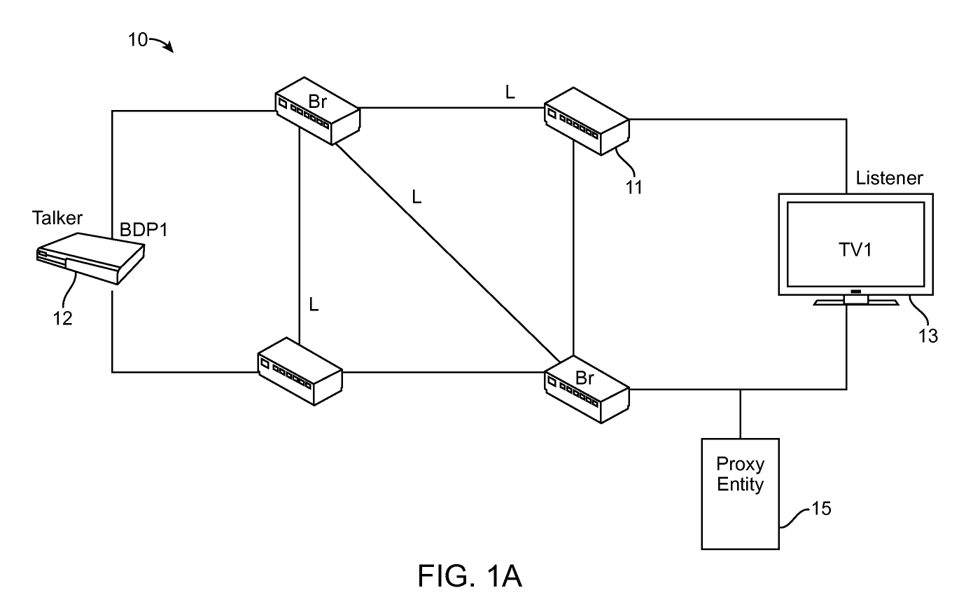

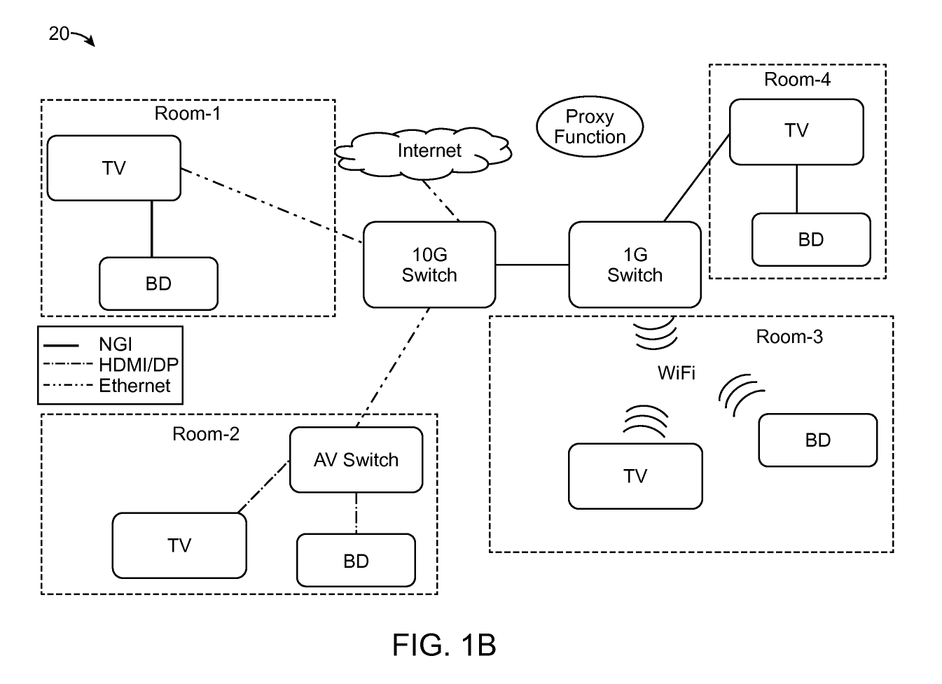

FIG. 1A shows an example AVB network 10, according to an embodiment of the invention, comprising a bridged network of devices including one or more bridge devices 11, a Talker device 12 and a Listener device 13, wherein the bridge devices connect the Talker device 12 and the Listener device 13 via communication links L forming at least one path therebetween for streaming AV content. The network 10 further includes at least one proxy entity 15, according to an embodiment of the invention.

According to an embodiment of the invention, an AV device may comprise an Application Layer (Layer 7) including processes that use the network, a Transport or TCP Layer (Layer 4) including processes that provide end-to-end data delivery, an IP Layer or Network/Internet Layer (Layer 3) including processes handling routing of data, a Link Layer (Layer 2) and a Physical Layer (Layer 1) for accessing physical communication medium. These layers are similar to TCP/IP layers which can be loosely mapped to the Open System Architecture (OSI). The Link Layer includes a MAC Layer and the Physical Layer includes a PHY Layer, configured for communication over an AV network.

Next Generation HDMI Interface, hereafter referred as NGI, may comprise the aforementioned AVB network including AVB end points optionally supporting ultra high speed Next Generation Interface (NGI) that could support at least 20 Gbps. It is expected that typical room-to-room network connections will support at least 1000BASE-T. However, 10GBASE-T and beyond will become common in the future.

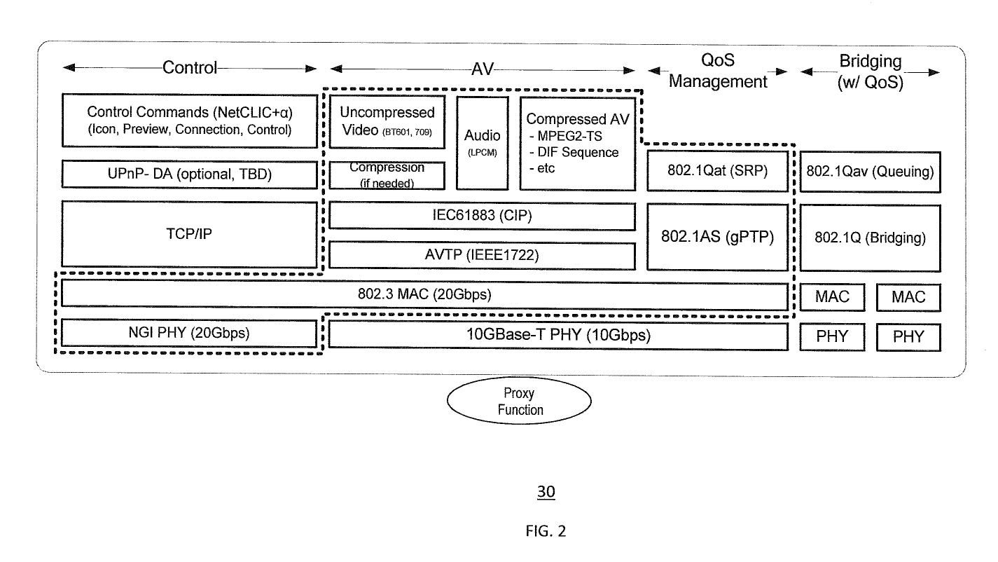

The streaming payload may comprise AV content that may be native video or AV content that is formatted by a display interface process such as HDMI, Display Port or DVI. A variety of video formats may be supported ranging from 3D, 4 KUD, HD, lossless and visually lossless. An example NGI network 20 is shown in FIG. 1B, implementing NGI protocol stack 30 based on IEEE 802.1AVB, 1722 and IEC61883, as shown in FIG. 2, according to an embodiment of the invention.

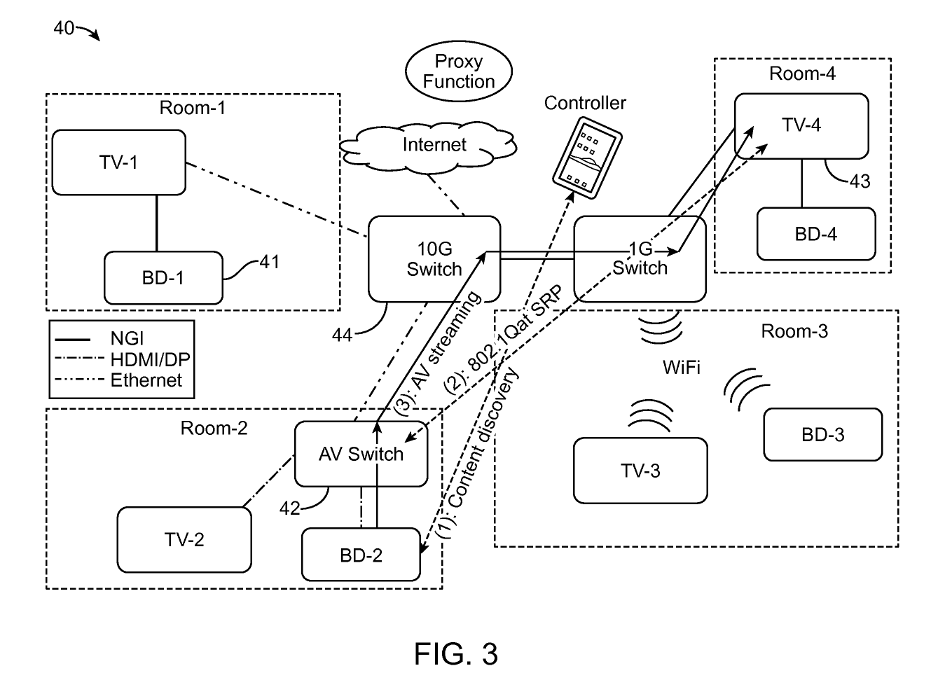

IEEE 802.1AS specifies transport of timing and synchronization in a network of bridges. AVB nodes comprise within a reserved path may implement IEEE 802.1Qav to govern forwarding and queuing of time sensitive AV data. The Multiple Multicast Registration Protocol (MMRP) may enable an AVB destination device to register the request for delivery of a specified AV stream. The function of the IEC61883 block is to packetize video received from the application layer and send it to the AVTP for transport. FIG. 3 illustrates AV streaming over multiple hops (physical links) and across domains in an AVB network 40, according to an embodiment of the invention. For example, BlueRay Disc Player (BD) in room-2 streams video to TV in room-4. The details of the scenario are summarized as follows. The source device 41 (e.g., BD-2) is connected to the AV Switch 42 using HDMI1.x. The AV switch 42 functions as a proxy device between HDMI1.x and NGI networks. The sink device 43 (e.g., TV-4) is connected to the switch 44 (e.g., 1G Switch) via the NGI network.

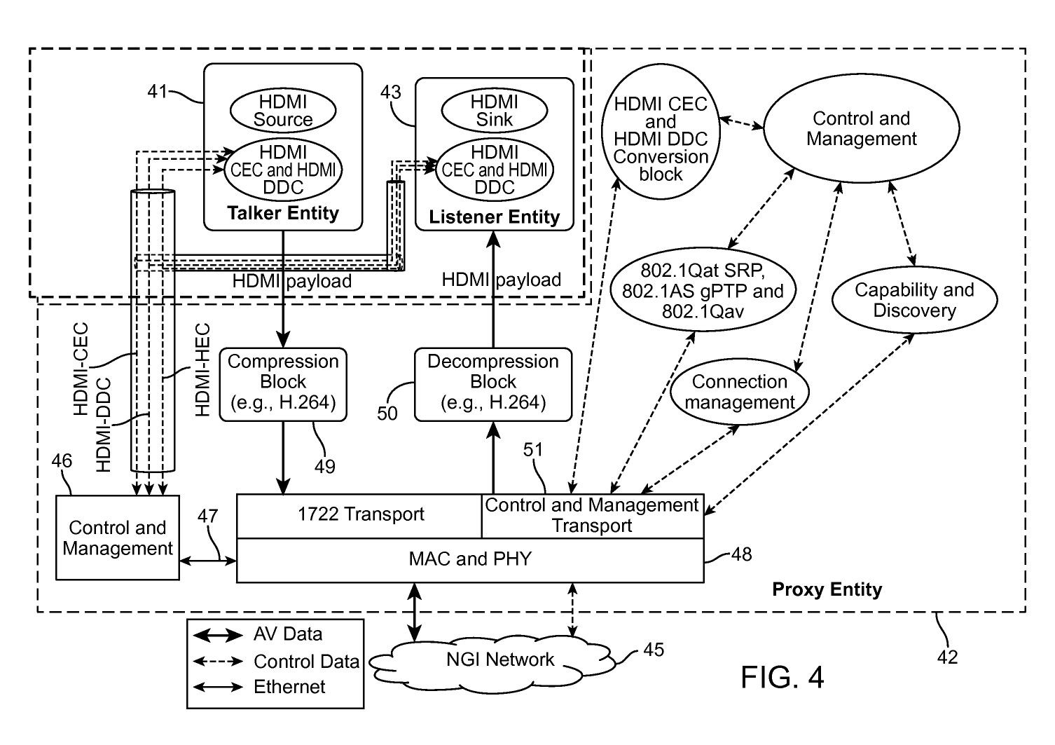

At a high level, a connection setup in the network follows the following steps. A user selects a particular AV content via an NGI controller device. IEEE 802.1AVB path set up messages are exchanged between the AV switch 42 and sink device 43 for setting up a path for AV streaming from source device 41 to sink device 43. AV streaming flows from source device 41 to sink device 43. FIG. 4 shows the architecture of an embodiment of a proxy entity such as the AB switch 42, which functions as a proxy device between source device 41 and NGI network 45, according to an embodiment of the invention.

As shown in FIG. 4, the proxy device 42 is connected to one HDMI source (i.e., HDMI1.x source) device 41 and one HDMI sink (i.e., HDMI1.x sink) device 43. HDMI source and sink devices (entities) 41 and 43 are represented as Talker and Listener entries, respectively. The HDMI HEAC, CEO and DDC channels from HDMI source and sink devices are connected to the control and management block 46 of the proxy device 42. Eventually, HEAC/DDC/CEC messages are multiplexed over the Ethernet link 47 and connected to the MAC/PHY layer of the proxy entity 48.

The Talker entity 41 is connected to the proxy entity 42 via a compression block 49. Similarly, the Listener entity 43 is connected to the proxy entity 42 via decompression block 50. In one embodiment, the compression block 49 performs lossless and visually lossless compression. In another embodiment, the compression block 49 does not perform any compression, hence, uncompressed video is transmitted. The decompression block 50 performs exactly opposite of the compression block. The compressed AV is transported over IEEE 1722. The control and management transport block 51 represents functionality of IEEE802.Qat SRP, IEEE802.1AS gPTP, IEEE802.1Qav, AV capability and discovery, HDMI CEO and HDMI DDC conversion block to NGI messages.

### Proxy Entity in Device Discovery

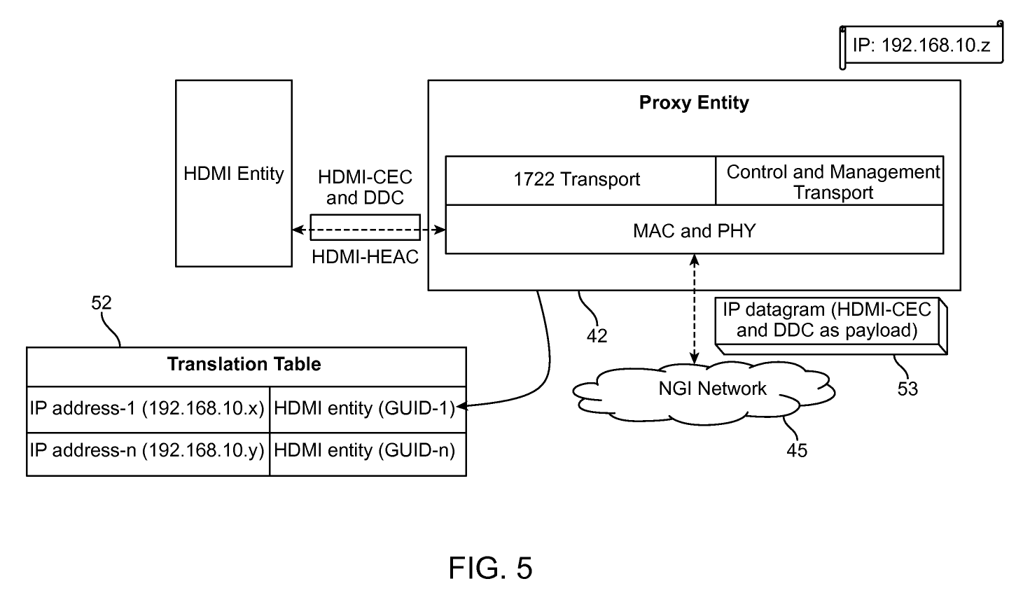

For HDMI1.x entities 41 and 43, the proxy entity 42 capable of NGI, assigns unique GUID (Global Unique ID) to such connected HDMI1.x entities. In addition, a unique IP address is assigned to HDMI1.x entities such that the proxy entity 42 and the connected HDMI1.x entities are in the same subnet. For example, if the proxy entity 42 has IP address of 192.168.10.z then the two connected HDMI1.x entities 41, 43 will have IP address of 192.168.10.x and 192.168.10.y, respectively. In addition, each entity 41, 43 has a unique GUID. As shown in FIG. 5, the proxy entity 42 maintains a Translation Table 52 for maintaining IP addresses, GUIDs, etc., according to an embodiment of the invention.

In one embodiment, the proxy entity 42 encapsulates HDMI-CEC and -DDC messages received via the control and management block 46 (FIG. 4) into an IP datagram 53 before transmitting it over the NGI network. In another embodiment, the proxy entity 42 de-encapsulates HDMI-CEC and -DDC messages from the received IP datagram on the NGI network 45 and forwards them to the corresponding HDMI1.x entity over Ethernet via said control and management block.

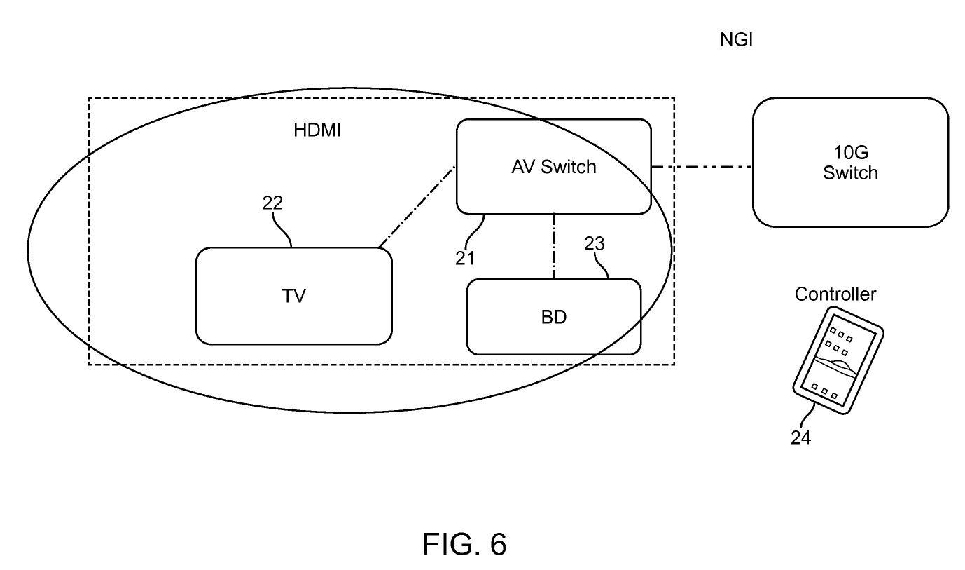

As shown in FIG. 6 in relation to network 30 of FIG. 2, the AV switch 21 is a proxy entity connected to HDMI1.x TV device 22 and BD device 23, according to an embodiment of the invention. A controller 24 discovers AV streams hosted at the BD device 23 via the proxy entity 21 on Layer-3 of the stack in FIG. 2. In one embodiment, HDMI CEC/DDC messages are converted into native NGI control and management messages by the proxy entity before transmitting them over the NGI network.

In one embodiment, IEEE 1722.1 can be used in the NGI, wherein Table 1 below includes modifications, according to an embodiment of the invention, to include messages for HDMI1.x or native NGI. For example, HDMI_CEC_Command and HDMI_CEC_Response are included. Similarly, HDMI_DDC_Command and HDMI_DDC_Response are included. When indicating HDMI_{—} in the message type, the receiver is notified that the sender is actually an HDMI1.x device.

TABLE 1
Proxy Entity in IEEE802.1Qat Stream Allocation and Transmission

| Value | Message Type | Meaning |
|---|---|---|
| 0 | AVDECC_MSG_COMMAND | The standard 1722.1 |
| | | defined command |
| 1 | AVDECC_MSG_RESPONSE | The standard 1722.1 |
| | | defined response |
| 2 | ADDRESS_ACCESS_COMMAND | Command to read part of |
| | | the address space of the |
| | | IEEE P1722.1 AVBDECC |
| | | entity. |
| 3 | ADDRESS_ACCESS_RESPONSE | Response containing the |
| | | contents of the part of the |
| | | address space of the IEEE |
| | | P1722.1 AVBDECC entity. |
| 4 | AVC_COMMAND | Standard AVC command |
| | | payload |
| 5 | AVC_RESPONSE | Standard AVC response |
| | | payload |
| 6 | VENDOR_UNIQUE_COMMAND | Vendor defined command |
| 7 | VENDOR_UNIQUE_RESPONSE | Vendor defined response |
| 8-13 | RESERVED | Reserved for future use |
| 14 | EXTENDED_COMMAND | Extended command |
| 15 | EXTENDED_RESPONSE | Extended response |

IEEE802.1Qat SRP registers a stream and reserves the resources required through the entire path taken by the stream. A Talker initiates by sending an SRP Talker Advertise message. AVB intermediate bridges receiving a Talker Advertise message check for bandwidth availability on their output ports. If a bridge has sufficient resources available on that port, then the Talker Advertise message is propagated to the next node. If the resources are not available, rather than propagating the Talker Advertise message, the bridge sends a Talker Failed message. An intermediate bridge receiving a Talker Failed message passes the message out towards the Listener.

The Listener can respond with a Listener Ready message that is forwarded back towards the Talker. Intermediate bridges use the Ready message to maintain the resources needed by the stream and to make the appropriate entries in their forwarding tables to allow the stream to be sent on the port that received the Ready message. When the Talker receives a Ready message, it can start transmitting the stream.

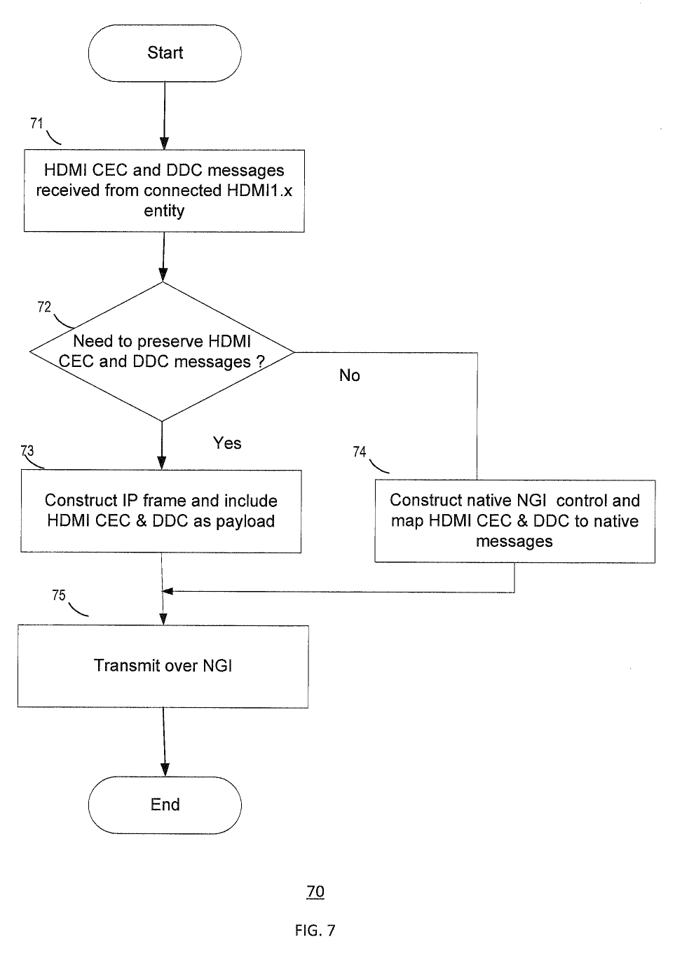

The proxy entity generates and processes IEEE802.1Qat SRP messages on behalf of connected HDMI1.x entities 42, 43. FIG. 7 shows a flowchart process 70 for proxy device transmission of HDMI1.x control messages, according to an embodiment of the invention. Process block 71 comprises receiving HDMI CEO and DDC messages from a connected HDMI1.x entity. Process block 72 comprises determining if there is a need to preserve said messages. If yes, the process proceeds to block 73, otherwise the process proceeds to process block 74. Process block 73 comprises constructing an IP frame and including HDMI CEO and DDC therein as payload. Process block 74 comprises constructing native NGI control messages and mapping HDMI CEO and DDC to native messages. Process block 75 comprises transmitting over the NGI network.

For example, the proxy entity 42 in FIG. 4 sends IEEE 802.1Qat Talker Advertise declaration to represent the AV stream hosted at device BD-2. In a similar manner, the proxy entity 42 generates SRP Listener declarations on behalf of connected HDMI1.x sink entities, such as TV-2 in FIG. 3. In addition, the proxy entity may also participate in MMRP to limit propagation of Talker Advertise on behalf of connected HDMI1.x entities. The IEEE 802.1Qat Talker Advertise includes the following fields:

StreamID
DataFrameParameter

Destination Address
Vlan_identifier

Tspec

MaxFrameSize
MaxIntervalFrame

PriorityAndRank

Data Frame priority
Rank

AccumulatedLatency

The proxy entity selects and maintains StreamiD for connected HDMI1.x Talker entities. The Tspec is selected based on many factors but not limited to capabilities of connected HDMI1.x source and remote HDMI1.x sink entity, minimum available bandwidth from the source to the sink. The proxy entity emulates the functioning of IEEE802.1 Qat. For example, if sufficient bandwidth is not available on the HDMI link between the proxy device 42 and HDMI1.x sink 43, the proxy entity 42 will not generate Listener Advertise message.

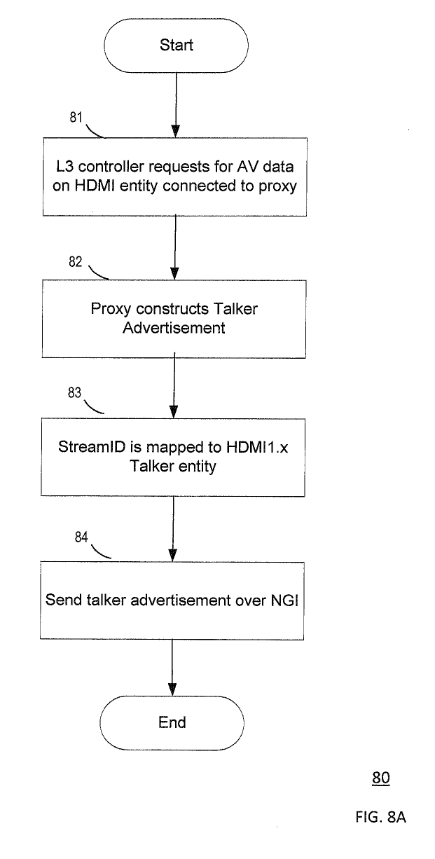

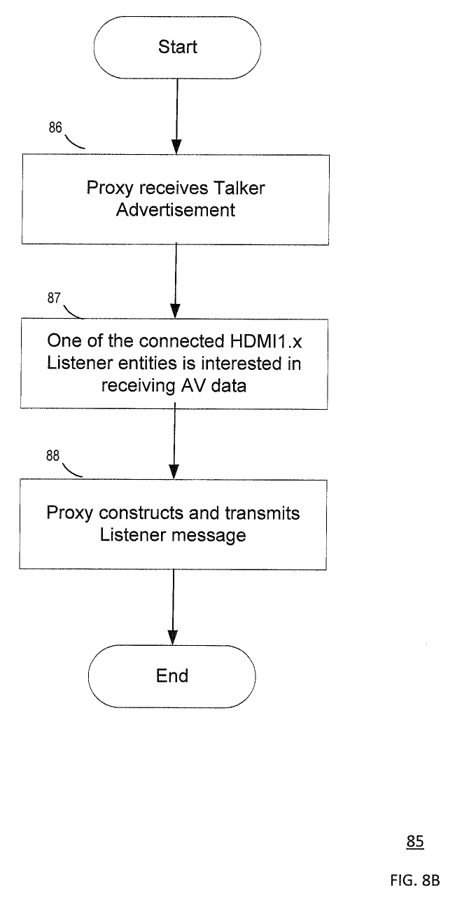

FIG. 8A and FIG. 8B show flowcharts of processes of IEEE802.1Qat SRP for talker and listener message processing by the proxy entity. FIG. 8A shows a flowchart of talker message processing 80 by the proxy entity, according to an embodiment of the invention. Process block 81 comprises Layer-3 (L3) controller requesting AV data on HDMI entity connected to the proxy device. Process block 82 comprises the proxy device constructing Talker Advertisement message. Process block 83 comprises mapping StreamiD to HDMI1.x talker. Process block 84 comprises sending Talker Advertisement message over the NGI network.

FIG. 8B shows a flowchart of listener message processing 85 by the proxy entity, according to an embodiment of the invention. Process block 86 comprises the proxy entity receiving a Talker Advertisement message. In process block 87 one of the connected HDMI1.x listener entities is interested in receivingAV data. In process block 88 the proxy entity constructs and transmits Listener message to the Listener.

The quality of video (e.g., uncompressed video, lossless compressed, visually compressed and compressed) is a factor of available bandwidth (or Tspec). Even when sufficient bandwidth is available, the option to select HDMI1.x or non-HDMI format is based on whether the sink entity is HDMI1.x.

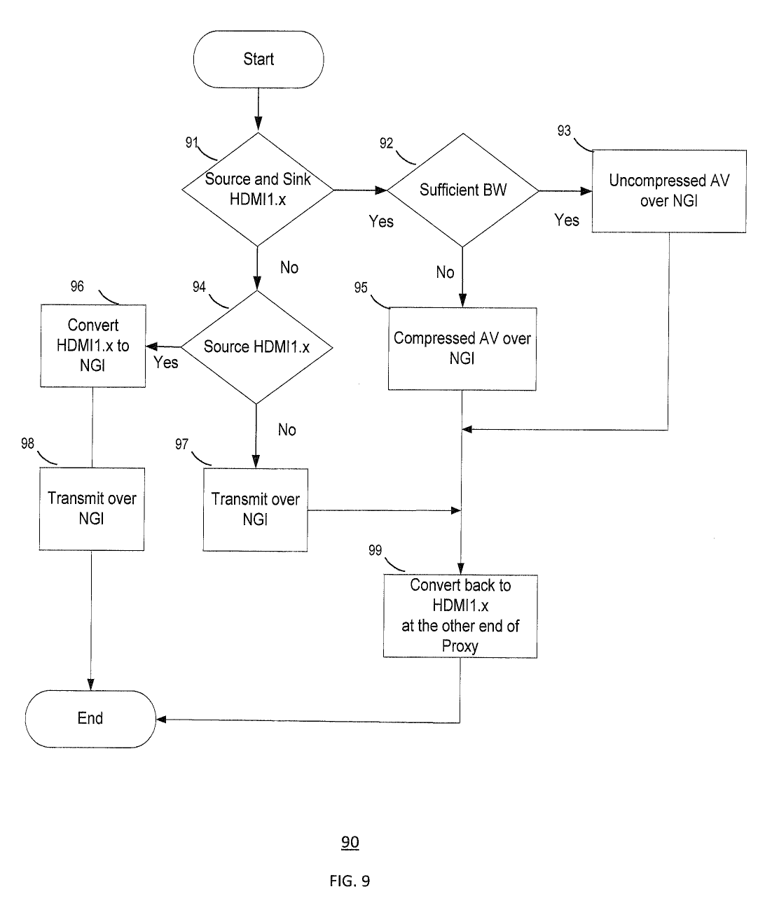

FIG. 9 shows a flowchart for process 90 for AV format selection (HDMI/compressed-HDMI or non-HDMI compressed), according to an embodiment of the invention. Process block 91 comprises determining if source and sink are HDMI1.x. If yes, then process block 92 comprises determining availability of sufficient bandwidth (BW) for streaming desired AV content. If sufficient BW, then process block 93 comprises selecting uncompressed AV content transmission over NGI network, and process block 99 comprises converting back to HDMI1.x at the other end of the proxy entity. In process block 92 if there is insufficient BW, then process block 95 comprises selecting compressed AV content transmission over the NGI network and proceeding to process block 99.

In process block 91 if source and sink are not HDMI1.x, the process block 94 comprises determining if the source is HDMI1.x. If not, process block 97 comprises selecting transmission of AV content over NGI network and proceeding to process block 99, otherwise process block 96 comprises converting HDMI1.x to NGI format. Then process block 98 comprises selecting transmission over NGI network.

AV data can be transmitted as HDMI or compressed-HDMI or non-HDMI compressed. HDMI format is wherein a pass through mode is used. In compressed HDMI, control portion of HDMI is extracted and sent separately. For example, AVI Info frame is extracted and sent using IEEE 1722 AVTP. Non-HDMI compressed uses H.264 codec, for example. In this case, HDMI control is not preserved.

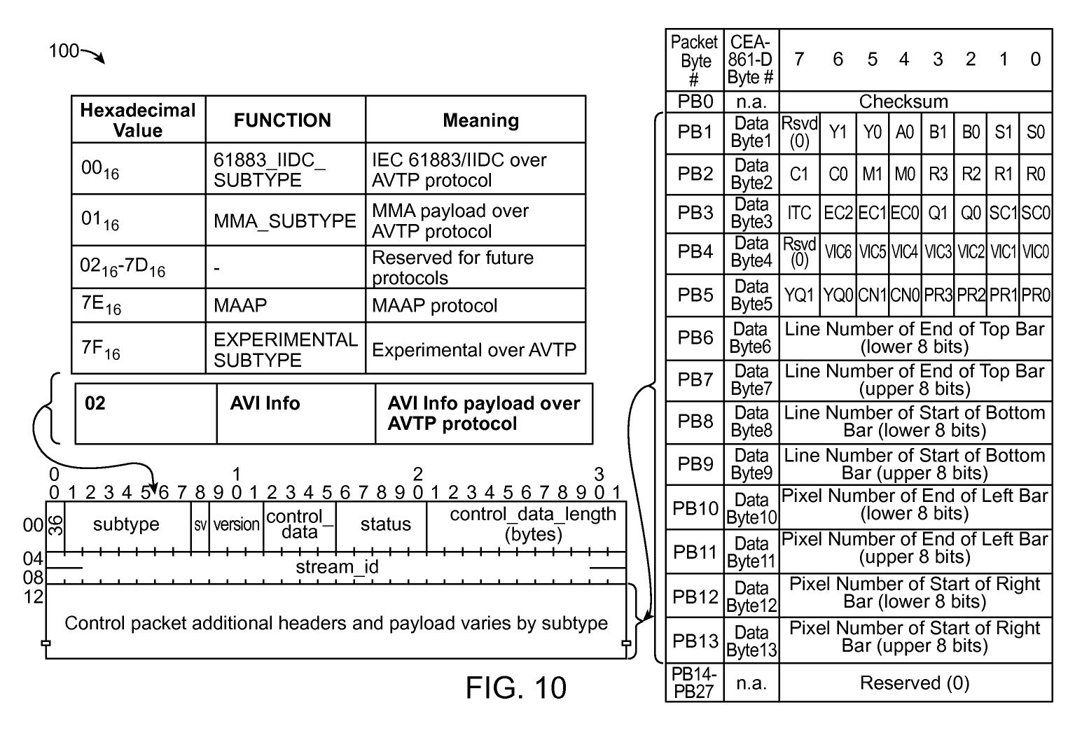

FIG. 10 shows a process 100 for transporting AVI Info over IEEE AVTP (IEEE Standard Layer 2 Transport Protocol for Time-Sensitive Application in Bridges Area Networks), according to an embodiment of the invention. A new type for AVI Info is added to AVTP subtype list [2]. The AVTP frame is formatted such that the AVTP subtype is set to AVI Info, the AVTP payload is set to HDMI AVI Info (PB1 to PB13) and the Stream id field is set to IEEE 802.1Qat Stream ID.

Embodiments of the invention allow Next Generation HDMI Interface interoperability with IEEE 802.1AVB. Existing HDMI1.x devices appear in Next Generation HDMI Interface network as another Next Generation HDMI Interface device.

As is known to those skilled in the art, the aforementioned example architectures described above can be implemented in many ways, such as program instructions for execution by a processor, as software modules, microcode, as computer program product on computer readable media, as logic circuits, as application specific integrated circuits, as firmware, as consumer electronic devices, etc., in wireless devices, in wireless transmitters/receivers, in wireless networks, etc. The disclosed embodiments can take the form of an entirely hardware embodiment, an entirely software embodiment or an embodiment containing both hardware and software elements.

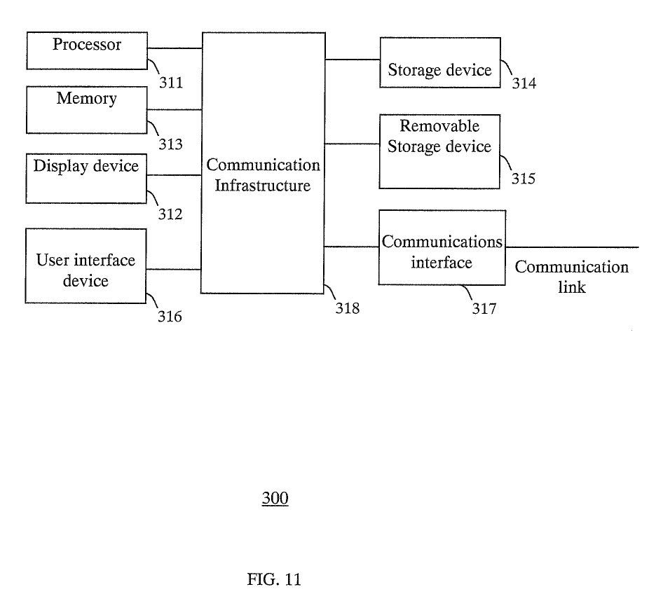

FIG. 11 is a high level block diagram showing an information processing system comprising a computer system 300 useful for implementing an embodiment of the present invention. The computer system 300 includes one or more processors 311, and can further include an electronic display device 312 (for displaying graphics, text, and other data), a main memory 313 (e.g., random access memory (RAM)), storage device 314 (e.g., hard disk drive), removable storage device 315 (e.g., removable storage drive, removable memory module, a magnetic tape drive, optical disk drive, computer readable medium having stored therein computer software and/or data), user interface device 316 (e.g., keyboard, touch screen, keypad, pointing device), and a communication interface 317 (e.g., modem, a network interface (such as an Ethernet card), a communications port, or a PCMCIA slot and card). The communication interface 317 allows software and data to be transferred between the computer system and external devices. The system 300 further includes a communications infrastructure 318 (e.g., a communications bus, cross-over bar, or network) to which the aforementioned devices/modules 311 through 317 are connected.

Information transferred via communications interface 317 may be in the form of signals such as electronic, electromagnetic, optical, or other signals capable of being received by communications interface 317, via a communication link that carries signals and may be implemented using wire or cable, fiber optics, a phone line, a cellular phone link, an radio frequency (RF) link, and/or other communication channels. Computer program instructions representing the block diagram and/or flowcharts herein may be loaded onto a computer, programmable data processing apparatus, or processing devices to cause a series of operations performed thereon to produce a computer implemented process.

Embodiments of the present invention have been described with reference to flowchart illustrations and/or block diagrams of methods, apparatus (systems) and computer program products according to embodiments of the invention. Each block of such illustrations/diagrams, or combinations thereof, can be implemented by computer program instructions. The computer program instructions when provided to a processor produce a machine, such that the instructions, which execute via the processor create means for implementing the functions/operations specified in the flowchart and/or block diagram. Each block in the flowchart /block diagrams may represent a hardware and/or software module or logic, implementing embodiments of the present invention. In alternative implementations, the functions noted in the blocks may occur out of the order noted in the figures, concurrently, etc.

The terms “computer program medium,” “computer usable medium,” “computer readable medium”, and “computer program product,” are used to generally refer to media such as main memory, secondary memory, removable storage drive, a hard disk installed in hard disk drive. These computer program products are means for providing software to the computer system. The computer readable medium allows the computer system to read data, instructions, messages or message packets, and other computer readable information from the computer readable medium. The computer readable medium, for example, may include non-volatile memory, such as a floppy disk, ROM, flash memory, disk drive memory, a CD-ROM, and other permanent storage. It is useful, for example, for transporting information, such as data and computer instructions, between computer systems. Computer program instructions may be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

Computer programs (i.e., computer control logic) are stored in main memory and/or secondary memory. Computer programs may also be received via a communications interface. Such computer programs, when executed, enable the computer system to perform the features of the present invention as discussed herein. In particular, the computer programs, when executed, enable the processor multi-core processor to perform the features of the computer system. Such computer programs represent controllers of the computer system.

Though the present invention has been described with reference to certain versions thereof; however, other versions are possible. Therefore, the spirit and scope of the appended claims should not be limited to the description of the preferred versions contained herein.

What is claimed is:

1. A method of communication in an Audio Video (AV) network, comprising:
a Talker device initiating communication with a Listener device via a proxy device for data streaming; and
the proxy device representing the Talker device and the Listener device in one or more of: content discovery, connection establishment, AV selection and AV streaming between the Talker device and the Listener device for data streaming therebetween.

2. The method of claim 1, further comprising:
the Talker device sending a message for streaming data to the Listener device;
the proxy device receiving the message and checking bandwidth availability on an output port thereof for the streaming; and
based on available communication bandwidth, the proxy device sending a message to the Talker device and/or the Listener device.

3. The method of claim 1, further comprising:
the proxy device representing connected HDMI1.x devices in the network.

4. The method of claim 3, wherein:
the proxy device comprises a Next Generation HDMI device that functions as a proxy between HDMI1.x devices and a next generation Next Generation HDMI Network.

5. The method of claim 4, further comprising:
the proxy device representing pseudo IEEE802.1AVB Talker and Listener devices mapped to HDMI1.x entities including HDMI1.x source and sink devices.

6. The method of claim 5, further comprising:
the proxy device negotiating IEEE802.1AVB connections on behalf of HDMI1.x source and sink devices.

7. The method of claim 6, further comprising:
the proxy device establishing IEEE802.1AVB connections on behalf of HDMI1.x source and sink devices.

8. The method of claim 7, further comprising:
the proxy device maintaining unique IDs for HDMI1.x entities.

9. The method of claim 8, further comprising:
the proxy device publishing AV content and capabilities of HDMI1.x entity at Layer-3 in Next Generation HDMI Interface.

10. The method of claim 1, further comprising:
the proxy device selecting AV format for transmission based on available network bandwidth and AV device capabilities in the network.

11. The method claim 2, further comprising:
the proxy device selecting AV content compression for transmission based on available network bandwidth and AV device capabilities in the network.

12. The method of claim 1 wherein the network comprises an Audio Video Bridging (AVB) network of AV devices.

13. A bridged Audio Video (AV) system, comprising:
a Talker device comprising a source HDMI entity;
a Listener device comprising a sink HDMI entity; and
a proxy device comprising a controller block that represents the Talker device and the Listener device in one or more of: content discovery, connection establishment, AV selection and AV streaming between the Talker device and the Listener device for data streaming therebetween.

14. The system of claim 13, wherein:
the proxy device comprises a compression block for compressing data for streaming; and
the proxy device comprises a decompression block for data decompressing streamed data.

15. The system of claim 14, wherein:
the proxy device assigns unique IDs to the Talker device and the Listener device;
the proxy device assigns IP addresses to the Talker device and the Listener device in the same subnet as the proxy entity; and
the proxy device maintains a translation table for the IP addresses.

16. The system of claim 15, wherein:
the proxy device encapsulates HDMI-CEC and HDMI-DDC messages received via the controller block from an HDMI entity, into an IP datagram before transmitting over a Next Generation Interface (NGI) network.

17. The system of claim 16, wherein:
the proxy device de-encapsulates HDMI-CEC and HDMI-DDC messages from a received IP datagram and forwards to a corresponding HDMI entity in the network.

18. The system of claim 13, further comprising:
a controller device that discovers AV streams hosted at an HDMI entity via the proxy device on Layer-3 of an NGI stack.

19. The system of claim 18, wherein:
the controller device converts HDMI CEC/DDC messages into native NGI messages before transmitting over an NGI network.

20. The system of claim 13, wherein:
the control device manages communication of HDMI1.x control messages between the HDMI entities, by selectively:
constructing an IP frame and including HDMI CEO and DDC messages therein as payload; and
constructing native NGI control and mapping HDMI CEO and DDC messages to native messages.

21. The system of claim 20, further comprising:
a Layer-3 controller that requests AV data on HDMI entity connected to the proxy device;
wherein the proxy device constructs Talker Advertisement message and sends that message over an NGI network.

22. The system of claim 21, wherein:
upon the proxy entity receiving a Talker Advertisement message for an AV stream, the proxy entity constructs and transmits a Listener message to the Listener device for the AV stream.

23. A bridged Audio Video (AV) system, comprising:
a Talker device comprising a source HDMI entity;
a Listener device comprising a sink HDMI entity; and
a proxy device comprising a controller block that represents the Talker device and the Listener device in one or more of: content discovery, connection establishment, AV selection and AV streaming between the Talker device and the Listener device for data streaming therebetween;
wherein the HDMI entities comprise HDMI1.x entities in an Audio Video Bridging (AVB) network, and the proxy device represents connected HDMI1.x entities in the network.

24. The system of claim 23, wherein:
the proxy device comprises a Next Generation HDMI device that functions as a proxy between HDMI1.x devices and a next generation Next Generation HDMI Network.

25. The system of claim 24, wherein:
the proxy device represents pseudo IEEE802.1AVB Talker and Listener devices mapped to HDMI1.x entities including HDMI1.x source and sink devices.

26. The system of claim 25, wherein the proxy device selectively:
negotiates IEEE802.1AVB connections on behalf of HDMI1.x source and sink devices;
establishes IEEE802.1AVB connections on behalf of HDMI1.x source and sink devices;
maintains unique IDs for HDMI1.x entities; and
publishes AV content and capabilities of HDMI1.x entity at Layer-3 in Next Generation HDMI Interface.

27. The system of claim 26, wherein the proxy device:
selects AV format for transmission based on available network bandwidth and AV device capabilities in the network; and
selects AV content compression for transmission based on available network bandwidth and AV device capabilities in the network.
